(19) United States
(12) Patent Application Publication
(10) Pub. No.: US 2012/0003410 A1
(43) Pub. Date: Jan. 5, 2012

(54) Partially crystalline cycloolefin elastomer medical tubing

(76) Inventor: Paul D. Tatarka, Union, KY (US)

(21) Appl. No.: 13/199,624

(22) Filed: Sep. 2, 2011

Related U.S. Application Data
(63) Continuation-in-part of application No. 13/066,118, filed on Apr. 7, 2011.
(60) Provisional application No. 61/403,095, filed on Sep. 10, 2010.
(60) Provisional application No. 61/342,527, filed on Apr. 15, 2010.

(51) Int. Cl. B32B 1/08

(52) U.S. Cl. 428/35.7

(57) ABSTRACT

Medical tubing made with a partially crystalline, cycloolefin elastomer of norbornene and ethylene typically having at least one glass transition temperature (Tg) in the range of from −10° C. to 15° C. and a crystalline melting temperature in the range of from 60° C. to 125° C. and a % crystallinity by weight in the range of from 5% to 40%.

### CROSS-REFERENCE TO RELATED APPLICATIONS

This application is based upon U.S. Provisional Patent Application Ser. No. 61/403,095, filed Sep. 10, 2010 of the same title. The priority of U.S. Provisional Patent Application Ser. No. 61/403,095 is hereby claimed and the disclosure thereof incorporated into this application in its entirety. This application is also a continuation in part of U.S. patent application Ser. No. 13/066,118, filed Apr. 7, 2011 entitled MELT BLENDS OF AMORPHOUS CYCLOOLEFIN POLYMERS AND PARTIALLY CRYSTALLINE CYCLOOLEFIN ELASTOMERS WITH IMPROVED TOUGHNESS, which was based on U.S. Provisional Patent Application Ser. No. 61/342,527, filed Apr. 15, 2010 of like title. The priorities of U.S. patent application Ser. No. 13/066,118 and Provisional Patent Application Ser. No. 61/342,527 are also hereby claimed and the disclosures thereof incorporated into this application in their entirety.

### TECHNICAL FIELD

The present invention is directed to medical tubing formed with partially crystalline norbornene/ethylene elastomer resins which provides an improved property profile; especially anti-kinking properties. Norbornene is also sometimes referred to as bicyclo[2.2.1]hept-2-ene or 2-norbornene:

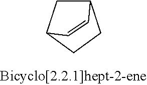

### BACKGROUND

In the medical field, where various agents are collected, processed and stored in containers, transported and ultimately delivered through tubes by infusion to patients, there has been a recent trend toward developing materials useful for fabricating such containers and tubing without the disadvantages of currently used materials such as polyvinyl chloride (PVC). These new medical tubing materials must have a unique combination of properties, so that the tubing can be used in fluid administration sets and with medical infusion pumps. These materials must have good bonding properties, sufficient yield strength and flexibility, be environmentally friendly and compatible with medical solutions, and exhibit little post-autoclave coil set.

It is a requirement that the tubing be environmentally compatible as a great deal of medical tubing is disposed of in landfills and through incineration. For tubing disposed of in landfills, it is desirable to use as little material as possible to fabricate the tubing. To this end, it is desirable to use a material which is thermoplastically recyclable so that scrap generated during manufacturing may be refabricated into other useful articles.

For tubing that is disposed of by incineration, it is necessary to use a material that does not generate or minimizes the formation of by-products such as inorganic acids which may be environmentally harmful, irritating, and corrosive. For example, polyvinyl chloride may generate objectionable amounts of hydrogen chloride (or hydrochloric acid when contacted with water) upon incineration, causing corrosion of the incinerator and possibly presenting other environmental concerns.

To be compatible with medical solutions, it is desirable that the tubing material be free from or have a minimal content of low molecular weight additives such as plasticizers, stabilizers, and the like. These components could be extracted by the therapeutic solutions that come into contact with the material. The additives may react with the therapeutic agents or otherwise render the solution ineffective. This is especially troublesome in bio-tech drug formulations where the concentration of the drug is measured in parts per million (ppm), rather than in weight or volume percentages. Even minuscule losses of the bio-tech drug can render the formulation unusable. Because bio-tech formulations can cost several thousands of dollars per dose, it is imperative that the dosage not be changed.

U.S. Pat. No. 4,041,103 to Davison et al. and U.S. Pat. No. 4,429,076 to Saito et al. disclose non-polyvinyl chloride polymeric blends of a polyamide and SEBS. However, the polymeric materials of these patents generally fail to provide the physical properties required for medical tubings. For example, Davison et al. disclose illustrative blends of various combinations of block copolymers, with nylons, and in some cases other components such as polypropylene and ethylene vinyl acetate copolymers. The majority of the blends of Davison et al. specify using nylon 6. The polymeric materials of Davison et al. are more suited to end uses which are subjected to high temperature oxidation environments such as automotive under-the-hood applications or electrical power cable applications. (Col. 6, line 67 to col. 7, line 3).

Saito et al. discloses a polymeric material having 1% to 99% SEBS and the balance being a polyamide. The polymeric compositions of Saito et al. are typically injection or blow molded into automobile parts, electrical parts, mechanical parts, medical equipment, packaging materials, and building materials. (Col. 16, lines 46-50).

Others have used SEBS in tubing and films as a component in a blend. U.S. Pat. No. 4,803,102 to Raniere et al. and U.S. Pat. No. 5,356,709 to Woo et al. disclose multilayered structures where SEBS blends are used as a layer within the multilayered structures.

See, also, JP Application No. 2000-151445 with respect to cycloolefin containing tubing.

Despite advances in the art, existing systems fail to provide a superior set of attributes, especially with respect to halogen free, all-olefin, kink-resistant tubing.

Details of the invention will be appreciated from the discussion hereinafter provided.

### SUMMARY OF INVENTION

The present invention provides halogen-free anti-kink medical tubing with all-olefin construction which is readily recycled and has outstanding chemical stability. The medical tubing is made with a partially crystalline elastomer of norbornene and ethylene which has a crystalline melting temperature in the range of from 60° C. to 125° C. and a % crystallinity by weight in the range of from 2.5% to 40%, more preferably from 5 to 40% by weight. The partially crystalline cycloolefin elastomer has at least one glass transition temperature (Tg) of less than 30° C., typically in the range of from −10° C. to 15° C. Optionally, it may also have multiple glass transitions; for example, one occurring at less than −90° C. and another which occurs in the range from −10° C. to 15° C. as described hereinafter.

### BRIEF DESCRIPTION OF DRAWINGS

The invention is described in detail below with reference to the drawings wherein:

FIG. 1 is a plot of Storage Modulus, E′ and Loss Modulus, E″, vs. temperature for norbornene/ethylene elastomer;

FIG. 2 is a plot of stress versus strain for partially crystalline cycloolefin elastomer, at temperatures of from 50° C. to −50° C.;

FIG. 3 is a plot of storage modulus versus temperature for cross-linked partially crystalline cycloolefin elastomer treated at various energies and dosages;

FIG. 4 is a plot of glass transition temperature (Tg) vs. norbornene content for amorphous COC resins;

FIG. 5 is a diagram in section of a multi-layer, single lumen cylindrical tube of the invention;

FIG. 6 is a diagram, in section, of a dual lumen cylindrical tube of the invention;

FIG. 7 is a diagram, in section, of a four lumen cylindrical tube of the invention; and

FIG. 8 is a diagram of another four lumen tube of the present invention.

### DETAILED DESCRIPTION

The invention is described below with reference to numerous embodiments. Such discussion is for purposes of illustration only. Modifications to particular examples within the spirit and scope of the present invention, set forth in the appended claims, will be readily apparent to one of skill in the art.

Terminology used herein is given its ordinary meaning consistent with the exemplary definitions set forth immediately below; % means weight percent or mol % as indicated, or in the absence of an indication, refers to weight percent. Mils refers to thousandths of an inch and so forth.

“Consisting essentially of” and like terminology refers to the recited components and excludes other ingredients which would substantially change the basic and novel characteristics of the composition or article. Unless otherwise indicated or readily apparent, a composition or article consists essentially of the recited components when the composition or article includes 90% or more by weight of the recited components. That is, the terminology excludes more than 10% unrecited components. Similarly, “substantially without” a certain ingredient indicates that a composition has less than 10% of that ingredient in the absence of more specific description of a composition. Preferably, “substantially without” indicates less than 5%, by weight, of the indicated ingredient and still more preferably less than 2.5 weight %.

“Amorphous cycloolefin polymer” and like terminology refers to a COP or COC polymer which exhibits a glass transition temperature, but does not exhibit a crystalline melting temperature nor does it exhibit a clear x-ray diffraction pattern.

“COC” polymer and like terminology refers to a cyclolefin copolymer prepared with acyclic olefin monomer and cyclolefin monomer by way of addition copolymerization.

“COP polymer” and like terminology refers to a cycloolefin containing polymer prepared exclusively from cycloolefin monomer, typically by ring opening polymerization.

Molecular weight of the amorphous cycloolefin copolymer is determined by means of gel permeation chromatography (GPC) in chloroform at 35° C., with the aid of an IR detector; the value is relative and based on a calibration using narrow-distribution polystyrene standards. The molecular weight of the cycloolefin polymers or copolymers can be controlled in a known manner by introduction of hydrogen, variation of the catalyst concentration or variation of the temperature. Molecular weight of the partially crystalline cycloolefin elastomers is measured by high temperature molar mass GPC in 1,2,4-trichlorobenzene at 140° C. using an appropriate standard and IR detector. Unless otherwise indicated, molecular weight refers to the weight average molecular weight.

Melt Volume Rate is measured in accordance with ISO Test Method 1133 at a load of 2.16 kg and a temperature of 260° C. for the partially crystalline cycloolefin elastomer and at a temperature of 230° C. for the amorphous cycloolefin polymer.

“Melt-blended” and like terminology refers to a process whereby polymers which are already formed such as COP, COC and COC elastomers are blended together in a molten state. Preferably, the COP, COC and COC elastomer polymers are substantially unreactive with each other and during the blending process as opposed to processes involving in situ polymerization and/or reaction between rigid polymer and elastomer ingredients as described in U.S. Pat. Nos. 7,026,401; 5,567,776; 5,494,969; 4,874,808; United States Patent Application Publication No. US 2005/0014898 and Japanese Publication No. JP 5271484, the disclosures of which are incorporated herein by reference.

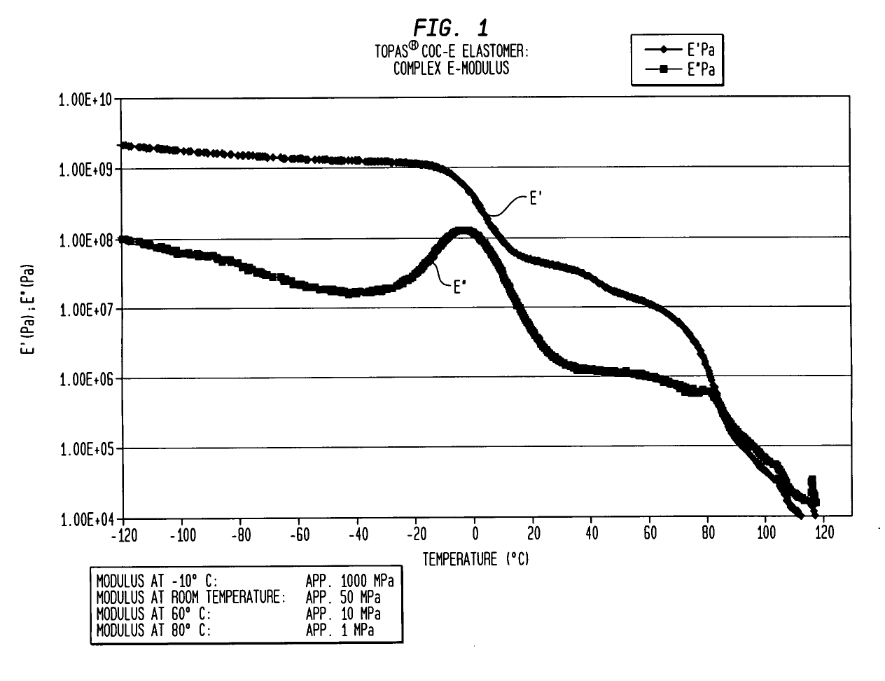

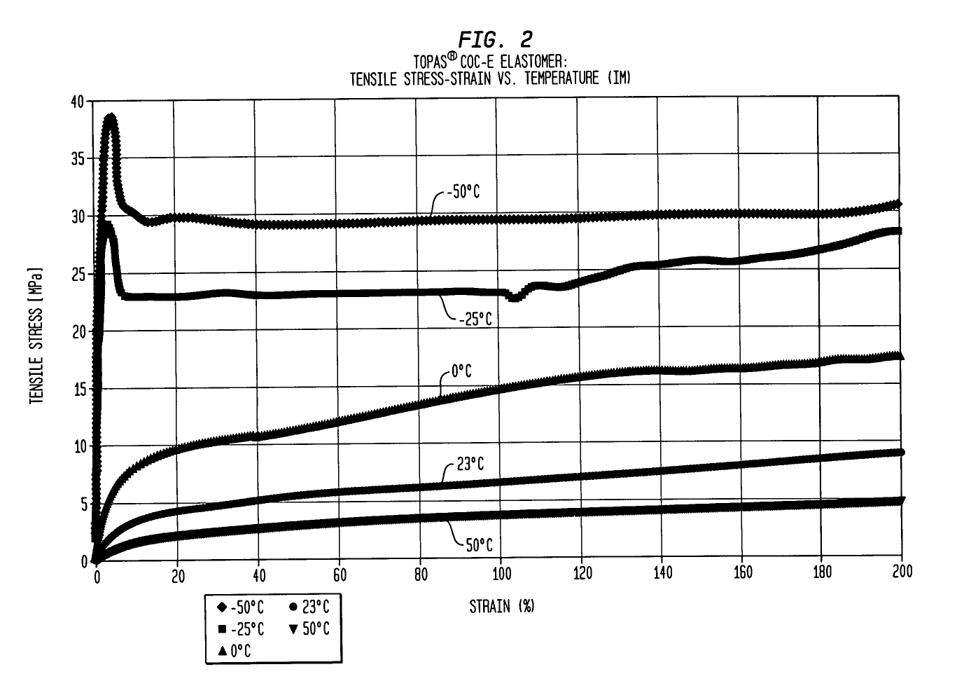

“Partially crystalline cycloolefin elastomer of norborene and ethylene”, and like terminology refers to a partially crystalline elastomer which contains cyclolefin repeat units, exhibits both a glass transition temperature and a melting point and rubbery modulus at room temperature and below. A typical elastomer, for example, is an ethylene/norbornene copolymer elastomer having a norbornene content of about 8-9 mol %, with a target of 8.5 mol %. It is seen hereinafter that partially crystalline COC elastomers may exhibit a rubbery modulus plateau between about 10° C. and 20° C. and 80° C. and 90° C. As to thermal properties and crystallinity, these polymers optionally feature two glass transition temperatures of about 6° C. and below about −90° C. as well as an exemplary crystalline melting point of about 84° C. These polymers exhibit flexibility and elastic behavior, that is, elongation before breaking of up to 200% and more at temperatures as low as −50° C. and below as is discussed herein in connection with FIGS. 1, 2. Unlike amorphous COP and COC polymers, these COC elastomers typically contain between 10 and 30 percent crystallinity. While these materials are typically prepared by the catalytic reaction of norbornene and ethylene as hereafter described, additional monomers may be included if so desired. Likewise, the materials may include grafted on units and crosslinkers if so desired and polymerization techniques such as ring opening metathesis may be employed. Preferably, the partially crystalline, cycloolefin elastomer of norbornene and ethylene is predominantly, more than 50% by weight, norbornene and ethylene repeat units, more preferably more than 80% by weight norbornene and ethylene repeat units and still more preferably, more than 90% by weight norbornene and ethylene repeat units.

Unless otherwise indicated, the Tg of the polymers was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis” (American Society for Testing of Materials, Philadelphia, Pa.).

Storage Modulus, E′ and Loss Modulus, E″, are measured by dynamic mechanical analysis (DMA), following ASTM D5026-06 and ASTM D4065-06 Test Methods, employing frequency of 1.0 Hz and a heating rate of 2° C. per minute over a temperature range of from −120° C. to 150° C. Storage or loss modulus may alternatively be measured in accordance with test methods ASTM D5279-08 (torsion) or ASTM D5023-07 (flexure).

Unless otherwise indicated, a Test Method in effect as of Mar. 1, 2010 is utilized.

### Cycloolefin Copolymer Elastomers

COC elastomers are elastomeric cyclic olefin copolymers also available from TOPAS Advanced Polymers. E-140 polymer features two glass transition temperatures, one of about 6° C. and another glass transition below −90° C. as well as a crystalline melting point of about 84° C. Unlike completely amorphous TOPAS COC grades, COC elastomers typically contain between 10 and 30 percent crystallinity by weight. Typical properties of E-140 grade appears in Table 1:

TABLE 1
E-140 Elastomer Properties

| Property | Value | Unit | Test Standard |
|---|---|---|---|
| Physical Properties | | | |
| Density | 940 | kg/m³ | ISO 1183 |
| Melt volume rate (MVR)- | 3 | cm³/10 min | ISO 1133 |
| @ 2.16 kg/190° C. | | | |
| Melt volume rate (MVR)- | 12 | cm³/10 min | ISO 1133 |
| @ 2.16 kg/260° C. | | | |
| Hardness, Shore A | 89 | — | ISO 868 |
| WVTR-@ 23° C./85 RH | 1.0 | g*100 μm/ | ISO 15106-3 |
| | | m²* day | |
| WVTR-@ 38° C./90 RH | 4.6 | g*100 μm/ | ISO 15106-3 |
| | | m²* day | |
| Mechanical Properties | | | |
| Tensile stress at break | >19 | MPa | ISO 527-T2/1A |
| (50 mm/min) | | | |
| Tensile modulus (1 mm/min) | 44 | MPa | ISO 527-T2/1A |
| Tensile strain at break | >450 | % | ISO 527-T2/1A |
| (50 mm/min) | | | |
| Tear Strength | 47 | kN/m | ISO 34-1 |
| Compression set- | 35 | % | ISO 815 |
| @ 24 h/23° C. | | | |
| Compression set- | 32 | % | ISO 815 |
| @ 72 h/23° C. | | | |
| Compression set- | 90 | % | ISO 815 |
| @ 24 h/60° C. | | | |
| Thermal Properties | | | |
| Tg-Glass transition temperature | 6 | ° C. | DSC |
| (10° C./min) | <−90 | | |
| Tₘ-Melt temperature | 84 | ° C. | DSC |
| Vicat softening temperature, | 64 | ° C. | ISO 306 |
| VST/A50 | | | |

As seen above, E-140 has multiple glass transitions (Tg); one occurs at less than −90° C. and the other occurs in the range from −10° C. to 15° C.

There is shown in FIG. 1 a plot of Storage Modulus, E′ and Loss Modulus, E″, versus temperature for E-140 copolymer elastomer having a norbornene content of about 8%-9% (mol %). Testing was conducted following ASTM D5026-06 and ASTM D4065-06 test methods. It is seen the partially crystalline COC elastomer exhibits a rubbery modulus plateau between about 10-20° C. and 80-90° C. The partially crystalline, ethylene/norbornene copolymer elastomer may have a norbornene content of from 1-20 mol % provided performance criteria are met.

It is seen from FIG. 1 that the cycloolefin elastomer exhibits a Storage Modulus between 10⁶ Pa and 10⁸ Pa over a temperature range of from 20° C. to 70° C. The material remains elastic and flexible over a much wider temperature range as can be appreciated from FIG. 2 which provides data for the E-140 grade.

COC elastomer generally has very broad service temperature range, which means the material will retain useful mechanical properties, especially flexibility, from <−90° C. to about 90° C. For example, in FIG. 2, tensile stress-strain of E-140 shows excellent ductility, in excess of 200 percent strain measured at −50° C., −25° C., 0° C., 23° C. and 50° C. E-140 typically exhibits an elongation at break of at least 50%, more typically at least 100% and preferably at least 200% at a temperature of −50° C. Elongation may be measured in accordance with ISO 527-T2/1A or any other suitable method. The upper limit is not precisely known but may be up to 300%, 500% or even 1000% at 0° C.

Under ISO 974: 2000(E) Determination of the Brittleness Temperature by Impact, E-140 did not fail at test temperatures of −50° C., −60° C., −70° C., −80° C. and −90° C. Failure is defined as breakage or any crack visible by the naked eye. Therefore, COC elastomers are suitable for device and packaging applications subject to cryogenic, freezer and refrigerator environments.

TABLE 1A
Low Temperature Brittleness Testing of Elastomer
BRITTLENESS TESTING PROCEDURE:

| Material | E-140 2 mm |
|---|---|
| Test Speed: | 2000 ± 200 mm/s |
| Specimen Dimensions | 20 ± 0.25 mm long by 2.5 ± 0.05 mm wide and |
| | 2.0 ± 0.1 mm thick |
| Specimen Preparation | Die Punched from supplied material in machine |
| | direction 3 ± 0.5 minutes at test temperature |
| Test Equipment: | Standard Scientific CS-153A-3 |
| Heat Transfer Medium | Methanol |
| Mounting Torque | 5 in-lb |

COC ELASTOMERS likewise have excellent abrasion resistance as is seen in Table 1B:

TABLE 1B
Abrasion resistance testing of Elastomer
ABRASION RESISTANCE TESTING PROCEDURE:

| Material | E-140 2 mm |
|---|---|
| Testing load | 10N |
| Specimen | Circular plaque with diameter of 16 ± 0.25 mm |
| Dimensions | and thickness of 2.0 ± 0.1 mm |
| Specimen | Punched from supplied material with circular die with |
| Preparation | |
| Test Equipment | DIN abrasion tester according to ISO 4649 |

Abrasion resistance of untreated TOPAS Elastomer E-140 is already very good as indicated by the low abrasion volume of 18 ml observed in a test run according to ISO 4649. Crosslinked material has even better mechanical properties as discussed hereinafter.

COC elastomers also have excellent electrical insulating properties. Dielectric constant (or relative permittivity) for E-140 is at or about 2.24, 2.21 and 2.27 at respective frequencies of 1, 5 and 10 GHz. Dissipation factor is at or about 0.00025, 0.00033 and 0.00028 at these same respective frequencies. Testing was conducted in accordance to the guidelines of ASTM D2520-01, Test Method B—Resonant Cavity Perturbation Technique.

Without intending to be bound by any particular theory, it is believed that the suitable COC elastomers have a very low norbornene-ethylene-norbornene (NEN) triad content and have 2 distinct block portions. One set of polymer blocks is thought to have a relatively high norbornene content and cannot crystallize, while another set of polymer block copolymers is thought to have a relatively low norbornene content and can partially crystallize.

Generally, suitable partially crystalline elastomers of norbornene and ethylene include from 0.1 mol % to 20 mol % norbornene, have at least one glass transition temperature of less than 30° C., a crystalline melting temperature of less than 125° C., and 40% or less crystallinity by weight. Particularly preferred elastomers exhibit a crystalline melting temperature of less than 90° C. and more than 60° C. Cycloolefin elastomers useful in connection with the present invention may be produced in accordance with the following: U.S. Pat. Nos. 5,693,728 and 5,648,443 to Okamoto et al.; European Patent Nos. 0 504 418 and 0 818 472 (Idemitsu Kosan Co., Ltd. and Japanese Patent No. 3350951, also of Idemitsu Kosan Co., Ltd., the disclosures of which are incorporated herein by reference.

Other norbornene/α-olefin copolymer elastomers are described in U.S. Pat. No. 5,837,787 to Harrington et al., the disclosure of which is incorporated herein by reference.

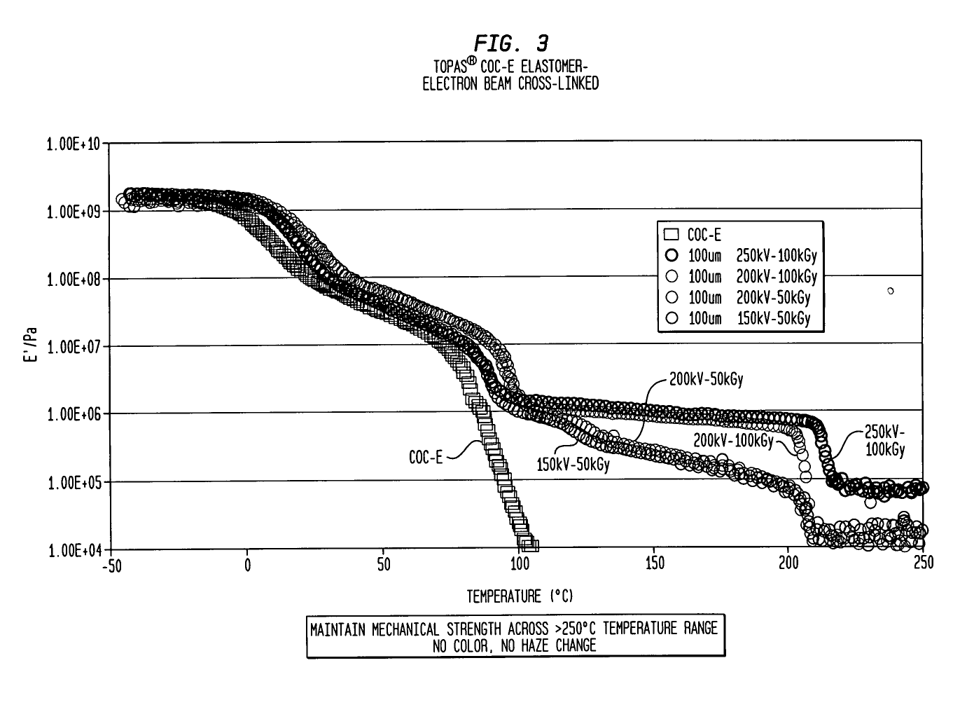

If high temperature performance is desired, the COC elastomer resin may be crosslinked by any suitable method, including with electron-beam (e-beam) radiation or by chemical means known in the art. Crosslinked COC elastomer resins have good optical clarity, are useful in blends, multilayer structures and are also useful in electronic and opto-electronic devices as is appreciated by one of skill in the art. Crosslinking with electron beam radiation extends useful mechanical properties in excess of 250° C. FIG. 3 shows the effect of e-beam cross linking on storage modulus of 100 micron E-140 film under beam energy range of 150-250 kV and radiation dosage range of 50-100 kGy. Significant amount of mechanical strength of non-crosslinked E-140 is lost at 90° C.-100° C. Crosslinking significantly improves and extends mechanical integrity in a range of 200° C. to more than 250° C. Cross-linking does not change transparency, color and haze of E-140 film.

Crosslinked COC elastomers are suitable for use in more aggressive environments. For example, many electrical and optical components used in electronic devices such as mobile phones and photovoltaic panels must be capable to endure 85° C. and 85 percent relative humidity environments. Crosslinked COC elastomers can be used as functional displays, lens, light guides, solar cell encapsulant films and front and back sheet for solar panels. UV resistance of crosslinked material is excellent, extending outdoor exposure without significant change in color and transparency as compared with non-crosslinked materials.

Crosslinked COC elastomers are a good alternative to moisture sensitive thermoplastic polyurethanes. However, crosslinked COC elastomers have a substantial improvement in abrasion resistance and are viable alternatives to polyurethanes for applications requiring high abrasion resistance such as laminate flooring and footwear. Thin films of crosslinked COC elastomers are an excellent laminating material for medical products, sporting equipment and camping gear.

### Amorphous Cyclolefin Containing Polymers

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Preference is given to cycloolefins of the formulae I, II, III, IV, V or VI, or a monocyclic olefin of the formula VII:

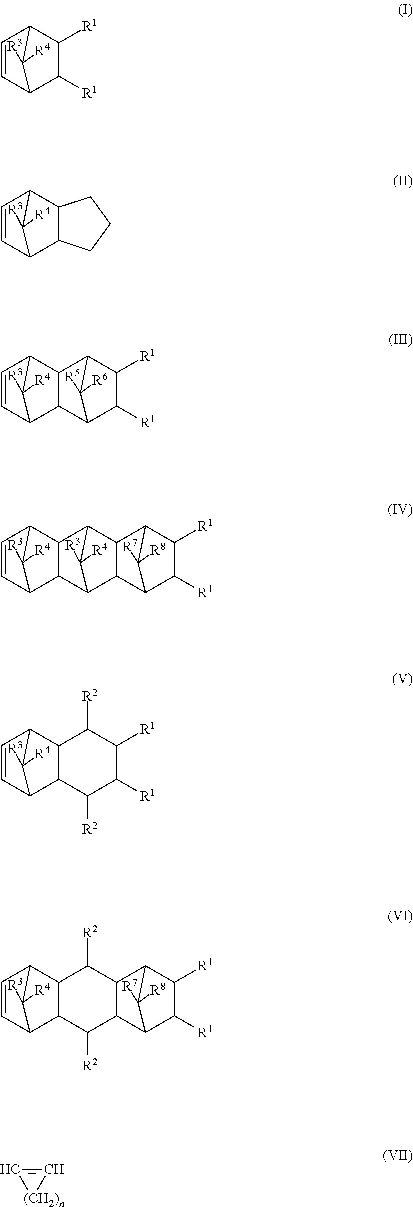

wherein R¹, R², R³, R⁴, R⁵, R⁶, R⁷ and R⁸ are the same or different and are H, a C₆-C₂₀-aryl or C₁-C₂₀-alkyl radical or a halogen atom, and n is a number from 2 to 10.

Specific cycloolefin monomers are disclosed in U.S. Pat. No. 5,494,969 to Abe et al. Cols. 9-27, for example the following monomers:

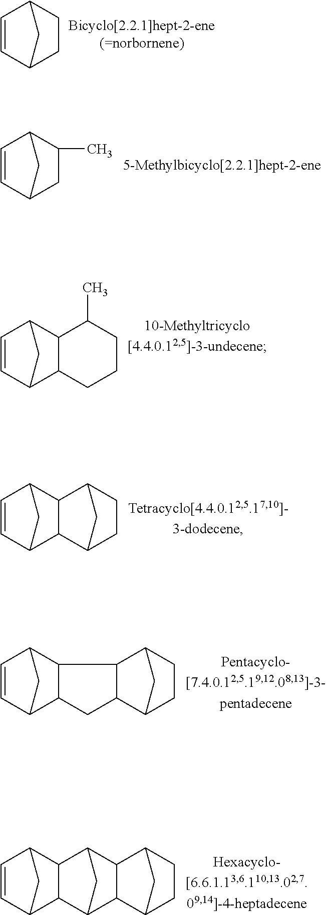

and so forth. The disclosure of U.S. Pat. No. 5,494,969 to Abe et al. Cols. 9-27 is incorporated herein by reference.

The above described cycloolefin monomers are incorporated into either COC or COP material in accordance with Scheme I above.

U.S. Pat. No. 6,068,936 and U.S. Pat. No. 5,912,070 disclose several cycloolefin polymers and copolymers, the disclosures of which are incorporated herein in their entirety by reference. Cycloolefin polymers useful in connection with the present invention can be prepared with the aid of transition-metal catalysts, e.g. metallocenes. Suitable preparation processes are known and described, for example, in DD-A-109 225, EP-A-0 407 870, EP-A-0 485 893, U.S. Pat. Nos. 6,489,016, 6,008,298, as well as the aforementioned U.S. Pat. Nos. 6,608,936, and 5,912,070, the disclosures of which are all incorporated herein in their entirety by reference. Molecular weight regulation during the preparation can advantageously be effected using hydrogen. Suitable molecular weights can also be established through targeted selection of the catalyst and reaction conditions. Details in this respect are given in the abovementioned specifications.

Particularly preferred cycloolefin copolymers include cycloolefin monomers and acyclic olefin monomers, i.e. the above-described cycloolefin monomers can be copolymerized with suitable acyclic olefin comonomers. A preferred comonomer is selected from the group consisting of ethylene, propylene, butylene and combinations thereof. A particularly preferred comonomer is ethylene. Preferred COCs contains about 10-80 mole percent of the cycloolefin monomer moiety and about 90-20 weight percent of the olefin moiety (such as ethylene). Cycloolefin copolymers which are suitable for the purposes of the present invention typically have a mean molecular weight M_{w} in the range from more than 200 g/mol to 400,000 g/mol. COCs can be characterized by their glass transition temperature, Tg, which is generally in the range from 20° C. to 200° C., preferably in the range from 30° C. to 130° C. In one preferred embodiment the cyclic olefin polymer is a copolymer such as TOPAS® 8007F-04 which includes approximately 36 mole percent norbornene and the balance ethylene. TOPAS® 8007F-004 has a glass transition temperature of about 78° C. Other preferred embodiments include melt blends of partially crystalline cycloolefin elastomer and amorphous COC materials with low glass transition temperatures. One preferred material for blending with partially crystalline cycloolefin elastomer is TOPAS® 9506-04 which has a Tg of about 68° C. Still another preferred amorphous COC for blending with partially crystalline cycloolefin elastomer is TOPAS® 9903D-10 which has a glass transition temperature of about 33° C.

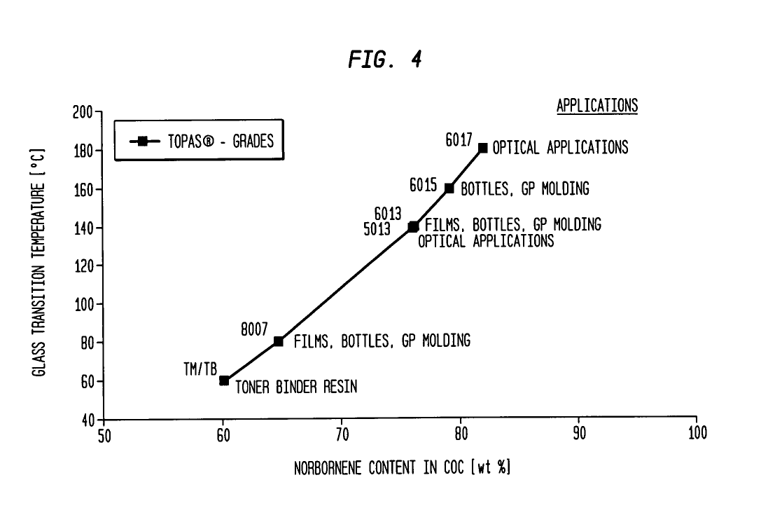

COCs are particularly preferred because their temperature performance can be tailored by changing the cycloolefin content of the polymer. There is shown in FIG. 4 a plot of glass transition temperature versus norbornene content for various commercial grades to TOPAS® COC materials.

Table 2 lists molecular weights of specific COC material and COC elastomer, specifically TOPAS® Elastomer E-140 (“E-140”) material discussed hereinafter.

TABLE 2
Melt Volume Flow Rate and Molecular Weight for TOPAS ® Materials

| | | | 9903- | 9506F- | | 8007F- | |
|---|---|---|---|---|---|---|---|
| | Units | E-140 | D10 | 04 | 8007F-04 | 400 | 6013F-04 |
| Melt Volume Rate | ml/10 min | 12 | 8 | — | 32 | — | 14 |
| at 260° C.; 2.16 kg load | | | | | | | |
| Method: ISO 1133 | | | | | | | |
| Melt Volume Rate | ml/10 min | — | 3.3 | 6 | 12 | 11 | 1 |
| at 230° C.; 2.16 kg load | | | | | | | |
| Method: ISO 1133 | | | | | | | |
| WeightAverage | | | | | | | |
| Molecular Weight (M_{w}) | | | | | | | |
| Chloroform at 35° C. | kg/mol | — | 138 | 114 | 98 | — | 87 |
| 1,2,4 Trichlorobenzol at | kg/mol | 154 | — | — | — | — | — |
| 140° C. | | | | | | | |
| Method GPC | | | | | | | |
| Number Average | | | | | | | |
| Molecular Weight (Mₙ) | | | | | | | |
| Chloroform at 35° C. | kg/mol | — | 42 | 55 | 40 | — | 40 |
| 1,2,4 Trichlorobenzol at | kg/mol | 68 | — | — | — | — | |
| 140° C. | | | | | | | |
| Method GPC | | | | | | | |
| Polydispersity | | 2.26 | 3.29 | 2.07 | 2.45 | — | 2.18 |

Suitable COC material is also available from Mitsui Petrochemical Industries of Tokyo, Japan. Suitable COP materials are available from Zeon Chemicals of Louisville Ky., under the trade name of Zeonex®, or from JSR Corporation of Tokyo, Japan, under the trade name of Arton®.

In addition to the amorphous cycloolefin containing resin and/OR partially crystalline cycloolefin elastomer copolymer, suitable additives are used depending upon the desired end-product. Examples of such additives include oxidative and thermal stabilizers, lubricants, release agents, flame-retarding agents, oxidation inhibitors, oxidation scavengers, neutralizers, antiblock agents, dyes, pigments and other coloring agents, ultraviolet light absorbers and stabilizers, organic or inorganic fillers including particulate and fibrous fillers, reinforcing agents, nucleators, plasticizers, waxes, melt adhesives, crosslinkers or vulcanizing agents and combinations thereof. In the Examples which follow, major components of each composition are listed in the tables. Pre-compounded compositions contained the following additives: 0.74% blue (decolorizing), 0.28% Licowax C (internal lubrication) and 0.28% Hostanox 010 (antioxidant).

Multilayer, all-olefin tubing can likewise be produced using the inventive compositions blended with or combined with layers of other polyolefins. Polyolefin polymers suitable for blending or combination include polyethylenes, polypropylenes, polybutenes, polymethylpentenes and so forth and are well known in the art. See Kirk-Othmer Encyclopedia of Chemical Technology, 3rd ed., Vol. 16, pp. 385-499, Wiley 1981, the disclosure of which is incorporated herein by reference. Such polymers are readily extruded into films and may be used to produce multilayer films in accordance with the invention as hereinafter described. “Polypropylene” includes thermoplastic resins made by polymerizing propylene with suitable catalysts, generally aluminum alkyl and titanium tetrachloride mixed with solvents. This definition includes all the possible geometric arrangements of the monomer unit, such as: with all methyl groups aligned on the same side of the chain (isotactic), with the methyl groups alternating (syndiotactic), all other forms where the methyl positioning is random (atactic), and mixtures thereof.

Polyethylenes are particularly useful because of their processability, mechanical and optical properties, as well as compatability with the polymer blends of the present invention. Polyethylene layers are typically formed with commercially available polymers and copolymers such as low density polyethylene, linear low density polyethylene (LLDPE), intermediate density polyethylene (MDPE) and high density polyethylene (HDPE). The differences between these materials includes density and degree of branching. LLDPE material generally display higher melting point, higher tensile, higher modulus, better elongation and stress crack resistance than LDPE materials of approximately the same melt index and density. LLDPE and LDPE generally have densities of from 0.90 to 0.94 g/cm³, while MDPE and HDPE typically have densities in the range of from 0.925-0.95 and >0.94 g/cc, respectively. Polyethylene is a semicrystalline thermoplastic whose properties depend to a major extent on the polymerization process (Saechtling, Kunststoff-Taschenbuch [Plastics Handbook], 27^{th} edition).

HDPE typically has a density of greater or equal to 0.941 g/cc. HDPE has a low degree of branching and thus stronger intermolecular forces and tensile strength. HDPE can be produced by chromium/silica catalysts, Ziegler-Natta catalysts or metallocene catalysts. The lack of branching is ensured by an appropriate choice of catalyst (e.g. Chromium catalysts or Ziegler-Natta catalysts) and reaction conditions.

LDPE typically has a density in the range of 0.910-0.940 g/cc. LDPE is prepared at high pressure with free-radical initiation, giving highly branched PE having internally branched side chains of varying length. Therefore, it has less strong intermolecular forces as the instantaneous-dipole induced-dipole attraction is less. This results in a lower tensile strength and increased ductility.

LLDPE is a substantially linear polyethylene, with significant numbers of short branches, commonly made by copolymerization of ethylene with short-chain α-olefins (e.g. copolymerization with 1-butene, 1-hexene, or 1-octene yield b-LLDPE, h-LLDPE, and o-LLDPE, respectively) via metal complex catalysts. LLDPE is typically manufactured in the density range of 0.915-0.925 g/cc. However, as a function of the α-olefin used and its content in the LLDPE, the density of LLDPE can be adjusted between that of HDPE and very low densities of 0.865 g/cc. Polyethylenes with very low densities are also termed VLDPE (very low density) or ULDPE (ultra low density). LLDPE has higher tensile strength than LDPE and exhibits higher impact and puncture resistance than LDPE. Lower thickness (gauge) films can be blown compared to LDPE, with better environmental stress cracking resistance compared to LDPE. Lower thickness (gauge) may be used compared to LDPE. Metallocene metal complex catalysts can be used to prepare LLDPEs with particular properties, e.g. high toughness and puncture resistance. Polyethylenes which are prepared with metallocene catalysts are termed “m-LLDPEs”. The variability of the density range of m-LLDPEs is similar to that of the density range of LLDPE, and grades with extremely low densities are also termed plastomers.

“MDPE” is polyethylene having a density range of 0.926-0.940 g/cc. MDPE can be produced by chromium/silica catalysts, Ziegler-Natta catalysts or metallocene catalysts. MDPE has good shock and drop resistance properties. It also is less notch sensitive than HDPE, stress cracking resistance is better than HDPE.

In the case of all of the types of polyethylene, there are commercial grades with very different flowabilities. Molecular weight can be lowered via control of the chain-termination reaction to such an extent that the product comprises waxes. HDPE grades with very high molecular weights are termed HMWPE and UHMWPE.

Multilayered tubing may be produced by co-extrusion. Co-extrusion is a well known process. U.S. Pat. Nos. 3,479,425; 3,959,431; and 4,406,547, the disclosures of which are incorporated herein by reference, describe co-extrusion processes. Medical tubing as described generally in U.S. Pat. No. 6,303,200 to Woo et al. was fabricated from the E-140, partially crystalline elastomer described above, alone or blended and/or layered with amorphous cycloolefin copolymer. The disclosure of U.S. Pat. No. 6,303,200 is incorporated herein by reference.

It has been unexpectedly found that if the tube wall has sufficient thickness, kink resistant tubing can be made with cyclolefin copolymer elastomer. Tubings were prepared from:
E-140
C09-10-5 (85/15 9506F-04/E-140)
C09-10-8 (40/40/20 9506F-04/6013M-07/E-140)
   The initially planned embodiments had dimensions of 0.100-inch ID and 0.138-inch OD; wall thickness of 0.015-inch.

All three of the above materials were successfully extruded into single lumen, monolayer tubing. These were done on a 1-inch extrusion line.

All samples were evaluated for kinking. Tubes are slowly bent together until kinked. PVC tubing does not kink. Kinking resistance is an important property because a kink will restrict and pinch off flow through the tube as noted above. C09-10-5 and C09-10-8 kinked readily after slight bending. Distortion and a heavy crease remained in the tube wall after releasing the kink. E-140 kinked too, however, this material nearly recovered its original shape after releasing the kink.

Additional embodiments included the following layer configuration and layer ratios:
E-140/C09-10-5/E-140 (Uniform wall thickness ratio: 1:1:1)
C09-10-8/E-140/C09-10-5
(Uniform wall thickness ratio: 1:1:1)
E-140/C09-10-5/E-140 (Wall thickness ratio of 1:2:1)
C09-10-8/E-140/C09-10-5 (Wall thickness ratio of 1:2:1)
   Dimensions of 0.100-inch ID and 0.138-inch OD; wall thickness of 0.015-inch were made.

Single lumen, three layer tubing was run on three ¾-inch extruders. Temperature profile used on all extruders from feed to die: 410, 410, 420 and 425° F.; adaptor and clamp 425° F. and die 425° F. Feed throats were cooled to 70° F.

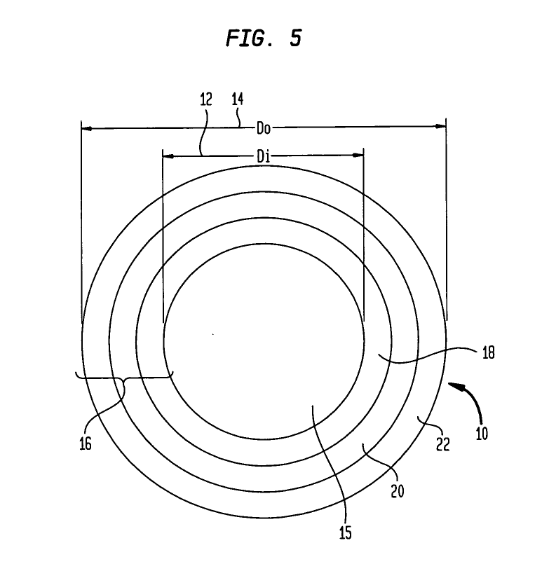

Single lumen, multilayer tubing with a thicker sidewall has the structure shown schematically in FIG. 5 where there is shown in cross-section a cylindrical, single lumen tube 10 with an inside diameter 12 of, for example, about 0.1 inches and an outside diameter 14 of, for example, 0.18 inches around lumen 15. A three-layer wall 16 similarly has a thickness of about 0.040 inches and includes a first layer 18 on the inside of the tube, a medial layer 20 and an outer layer 22. The layers may have various compositions, for example, one or more layers may contain or consist essentially of a partially crystalline, cycloolefin elastomer of norbornene and ethylene, while the other layers may consist of polyethylene or polypropylene. At least one layer contains a partially crystalline, cycloolefin elastomer which may be melt blended, for example, with an amorphous cycloolefin containing polymer. The various layers may be of uniform thickness as shown or it may be preferred to vary the thicknesses depending upon materials and desired properties.

Since E-140 monolayer tubing appeared promising, additional runs were made.

Wall thickness E-140 tubing with constant ID of 0.100-inch was increased in 0.005-inch increments from 0.015 to 0.040-inch. As the wall thickness increased, kink resistance improved. Wall thickness of 0.035 and 0.0400-inch was sufficient to make the tube kink resistant.

Kink resistance is both tube geometry and material dependent as is seen from the following data which include monolayer specimens from the foregoing trials:

### E-140

ID: 0.096-inch
OD: 0.138-inch
Wall: 0.020-inch (20-mil) (Kinked)

### E-140

ID: 0.117-inch
OD: 0.181-inch
Wall: 0.030-inch (30-mil) (Kinked)

### E-140

ID: 0.108-inch
OD: 0.185-inch
Wall: 0.040-inch (40-mil) (no Kink)
All 100% E-140 tubes are very flexible.
E-140 tubing with 15, 25 and 35-mil wall thickness were also prepared. 35-mil is kink resistant, thinner walled tubes are not.
Other comparative samples were made at the following dimension (This geometry is common for PVC tubing which is kink resistant):
ID: 0.100-inch
OD: 0.138-inch
Wall: 0.015-inch (15-mil)

### C09-10-5: (85/15 9506F-04/E-140)

### C09-10-8: (40/40/20 9506F-04/6013M-07/E-140)

C09-10-5 and C09-10-8 tubes are very stiff.
All tubing was monolayer in the comparative blend examples immediately above.
Tube geometry is application specific. Current trends include smaller diameter, soft feel and high flow.

While single lumen tubing was tested, one of skill in the art will appreciate that multi-lumen tubing is readily prepared as well.

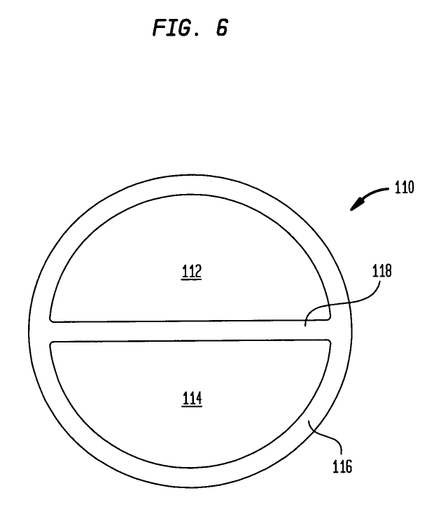

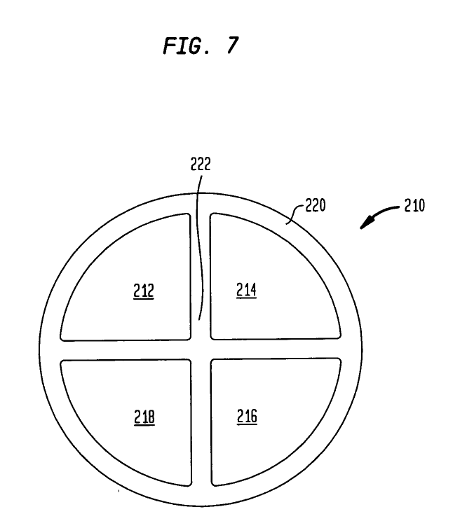

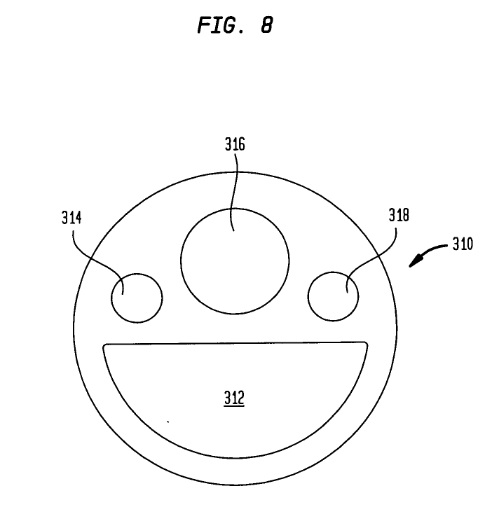

Multi-lumen tubes may have the structure shown in FIG. 6, FIG. 7, FIG. 8, or a multitude of other geometries as will be appreciated by one of skill in the art. There is shown in FIG. 6 a cylindrical tube 110 having two lumens 112, 114, an outer wall 116 and an internal dividing wall 118. FIG. 7 similarly shows a four lumen construction of a tube 210 with lumens 212, 214, 216 as well as an outer wall 220 and an internal divider 222 which defines the four lumens. In the embodiment shown in FIG. 7, the four lumens are of equal cross-section but other geometries may be utilized as shown in FIG. 8. In FIG. 8, there is shown a four lumen tube 310 having in one-half of the tube a large lumen 312 of semi-circular cross-section as well as smaller lumens 314, 316 and 318 which may be of the same or different size.

The tube structures shown in FIGS. 5, 6, 7 and 8 are readily prepared on conventional extrusion equipment. For structures other than single lumen tubes, the inside diameter and/or inside diameter/wall thickness ratio is calculated by disregarding internal dividing walls such as wall 116 of FIG. 6 and divider 222 of FIG. 7. For more complex structures as shown in FIG. 8, the inside diameter/wall thickness ratio is calculated by dividing the largest cross-sectional dimension of the largest lumen by the average wall thickness around that lumen. Likewise, for complex structures, the wall thickness is taken as the average wall thickness around the largest lumen of the structure.

### Further Embodiments

In additional aspects of the invention, there is provided medical tubing formed from the melt blends of embodiments 1-56 or incorporating a layer formed of the melt blends of embodiments 1-56 or incorporating a polymer described in embodiments 1-56.

Embodiment No. 1 is a melt-blend resin composition prepared by melt-blending: (a) from 60 parts to 99 parts per hundred weight resin in the blend of an amorphous cycloolefin polymer composition exhibiting a glass transition temperature (Tg) in the range of from 30° C. to 200° C.; and (b) from 40 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 2 is the melt-blend resin composition according to Embodiment No. 1, wherein the blend contains from 65 parts to 97.5 parts per hundred weight resin in the blend of the amorphous cycloolefin copolymer composition exhibiting a glass transition temperature in the range of from 30° C. to 200° C. and from 35 parts to 2.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 3 is the melt-blend resin composition according to Embodiment No. 1, wherein the blend contains from 75 parts to 95 parts per hundred weight resin in the blend of the amorphous cycloolefin copolymer composition exhibiting a glass transition temperature in the range of from 30° C. to 200° C. and from 25 parts to 5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 4 is the melt-blend resin composition according to Embodiment No. 1, wherein the blend contains from 85 parts to 92.5 parts per hundred weight resin in the blend of the amorphous cycloolefin copolymer composition exhibiting a glass transition temperature in the range of from 30° C. to 200° C. and from 15 parts to 7.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 5 is the melt-blend resin composition according to Embodiment No. 1, wherein the blend contains from 77.5 parts to 82.5 parts per hundred weight resin in the blend of the amorphous cycloolefin copolymer composition exhibiting a glass transition temperature in the range of from 30° C. to 200° C. and from 17.5 parts to 22.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 6 is the melt-blend resin composition according to Embodiment No. 1, wherein the amorphous cycloolefin copolymer composition has a Tg in the range of from 40° to 150° C.

Embodiment No. 7 is the melt-blend resin composition according to Embodiment No. 1, wherein the amorphous cycloolefin copolymer composition has a Tg in the range of from 100° to 135° C.

Embodiment No. 8 is the melt-blend resin composition according to Embodiment No. 1, wherein the amorphous cycloolefin copolymer composition has a Tg in the range of from 30° to 70° C.

Embodiment No. 9 is the melt-blend resin composition according to Embodiment No. 1, wherein the amorphous cycloolefin copolymer composition has a Tg in the range of from 30° to 40° C.

Embodiment No. 10 is the melt-blend resin composition according to Embodiment No. 1, wherein the partially crystalline elastomer of norbernene and ethylene has at least one glass transition temperature (Tg) in the range of from −10° C. to 15° C. and a crystalline melting temperature in the range of from 60° C. to 125° C. and a % crystallinity by weight in the range of from 2.5% to 40%.

Embodiment No. 11 is the melt-blend resin composition according to Embodiment No. 10, wherein the partially crystalline elastomer of norbornene and ethylene has at least one glass transition temperature (Tg) in the range of from 0° to 10° C.

Embodiment No. 12 is the melt-blend resin composition according to Embodiment No. 10, wherein the partially crystalline, cycloolefin elastomer of norbornene and ethylene exhibits at least one glass transition temperature (Tg) in the range of from −10° C. to 15° C. and at least a second glass transition temperature (Tg) at less than −90° C.

Embodiment No. 13 is the melt-blend resin composition according to Embodiment No. 1, wherein the partially crystalline elastomer of norbornene has a Melt Volume Rate @ 230° C. and 2.16 kg load of from 0.25 to 25.

Embodiment No. 14 is the melt-blend resin composition according to Embodiment No. 10, wherein the partially crystalline elastomer of norbornene has a Melt Volume Rate @ 230° C. and 2.16 kg load of from 0.5 to 2.

Embodiment No. 15 is the melt-blend resin composition according to Embodiment No. 10, wherein the partially crystalline elastomer of norbornene has a Melt Volume Rate @ 230° C. and 2.16 kg load of from 2.5 to 4.5.

Embodiment No. 16 is the melt-blend resin composition according to Embodiment No. 10, wherein the partially crystalline elastomer of norbornene has a Melt Volume Rate @ 230° C. and 2.16 kg load of from 4 to 8.

Embodiment No. 17 is the melt-blend resin composition according to Embodiment No. 10, wherein the partially crystalline elastomer of norbornene has a Melt Volume Rate @ 230° C. and 2.16 kg load of from 8 to 15.

Embodiment No. 18 is the melt-blend resin composition according to Embodiment No. 10, wherein the partially crystalline elastomer of norbornene and ethylene has a melting temperature in the range of from 70° to 100° C.

Embodiment No. 19 is the melt-blend resin composition according to Embodiment No. 10, wherein the partially crystalline elastomer of norbornene and ethylene has a melting temperature in the range of from 80° to 90° C.

Embodiment No. 20 is the melt-blend resin composition according to Embodiment No. 10, wherein the partially crystalline elastomer of norbornene and ethylene has a % crystallinity by weight in the range of from 5% to 40%.

Embodiment No. 21 is the melt-blend resin composition according to Embodiment No. 10, wherein the partially crystalline elastomer of norbornene and ethylene has a % crystallinity by weight in the range of from 10% to 30%.

Embodiment No. 22 is the melt-blend resin composition according to Embodiment No. 10, wherein the partially crystalline elastomer of norbornene and ethylene has a norbornene content in the range of from 3 mol % to 20 mol %.

Embodiment No. 23 is the melt-blend resin composition according to Embodiment No. 10, wherein the partially crystalline elastomer of norbornene and ethylene has a norbornene content in the range of from 5 mol % to 15 mol %.

Embodiment No. 24 is the melt-blend resin composition according to Embodiment No. 10, wherein the partially crystalline elastomer of norbornene and ethylene has a norbornene content in the range of from 7 mol % to 11 mol %.

Embodiment No. 25 is the melt-blend resin composition according to Embodiment No. 10, wherein the partially crystalline elastomer of norbornene and ethylene has a weight average molecular weight in the range of from 25,000 to 500,000 Daltons.

Embodiment No. 26 is the melt-blend resin composition according to Embodiment No. 10, wherein the partially crystalline elastomer of norbornene and ethylene has a weight average molecular weight in the range of from 50,000 to 450,000 Daltons.

Embodiment No. 27 is the melt-blend resin composition according to Embodiment No. 10, wherein the partially crystalline elastomer of norbornene and ethylene has a weight average molecular weight in the range of from 75,000 to 300,000 Daltons.

Embodiment No. 28 is the melt-blend resin composition according to Embodiment No. 10, wherein the partially crystalline elastomer of norbornene and ethylene has a weight average molecular weight in the range of from 100,000 to 200,000 Daltons.

Embodiment No. 29 is the melt-blend resin composition according to Embodiment No. 10, wherein the partially crystalline elastomer of norbornene and ethylene exhibits a Melt Volume Rate @ 260° C. and 2.16 kg load of from 2 ml/10 min to 50 ml/10 min.

Embodiment No. 30 is the melt-blend resin composition according to Embodiment No. 10, wherein the partially crystalline elastomer of norbornene and ethylene exhibits a Melt Volume Rate @ 260° C. and 2.16 kg load of from 4 ml/10 min to 35 ml/10 min.

Embodiment No. 31 is the melt-blend resin composition according to Embodiment No. 10, wherein the partially crystalline elastomer of norbornene and ethylene exhibits a Melt Volume Rate @ 260° C. and 2.16 kg load of from 6 ml/10 min to 24 ml/10 min.

Embodiment No. 32 is the melt-blend resin composition according to Embodiment No. 10, wherein the partially crystalline elastomer of norbornene and ethylene exhibits a Melt Volume Rate @ 260° C. and 2.16 kg load of from 8 ml/10 min to 16 ml/10 min.

Embodiment No. 33 is the melt-blend resin composition according to Embodiment No. 1, wherein the partially crystalline elastomer exhibits an elongation at break of at least 50% at a temperature of −50° C.

Embodiment No. 34 is the melt-blend resin composition according to Embodiment No. 1, wherein the partially crystalline elastomer exhibits an elongation at break of at least 75% at a temperature of −50° C.

Embodiment No. 35 is the melt-blend resin composition according to Embodiment No. 1, wherein the partially crystalline elastomer exhibits an elongation at break of at least 100% at a temperature of −50° C.

Embodiment No. 36 is the melt-blend resin composition according to Embodiment No. 1, wherein the melt-blend resin composition consists essentially of: (a) from 60 parts to 99 parts per hundred weight resin in the blend of an amorphous cycloolefin polymer composition exhibiting a glass transition temperature in the range of from 30° C. to 200° C.; and (b) from 40 parts to 1 part per hundred weight resin in the blend of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 37 is the melt-blend resin composition according to Embodiment No. 1, wherein the composition exhibits characteristic localized stress whitening only upon high speed impact testing in accordance with ASTM Test Method D 3763.

Embodiment No. 38 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 3.

Embodiment No. 39 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 2.

Embodiment No. 40 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 1.

Embodiment No. 41 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 0.5.

Embodiment No. 42 is a melt-blend resin composition prepared by melt-blending: (a) from 60 parts to 99 parts per hundred weight resin in the blend of an amorphous cycloolefin polymer composition consisting essentially of one or more copolymers of ethylene and norbornene exhibiting a glass transition temperature in the range of from 30° C. to 200° C.; and (b) from 40 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 43 is the melt-blend resin composition according to Embodiment No. 42, comprising an amorphous cycloolefin polymer of ethylene and norbornene having a weight average molecular weight of from 25,000 Daltons to 400,000 Daltons.

Embodiment No. 44 is the melt-blend resin composition according to Embodiment No. 42, comprising an amorphous cycloolefin polymer of ethylene and norbornene having a weight average molecular weight of from 50,000 Daltons to 250,000 Daltons.

Embodiment No. 45 is the melt-blend resin composition according to Embodiment No. 42, comprising an amorphous cycloolefin polymer of ethylene and norbornene having a weight average molecular weight of from 75,000 Daltons to 150,000 Daltons.

Embodiment No. 46 is a melt-blend resin composition prepared by melt-blending: (a) from 20 parts to 60 parts per hundred weight resin in the blend of a first amorphous cycloolefin polymer composition exhibiting a first glass transition temperature (Tg); (b) from 20 parts to 60 parts per hundred weight resin in the blend of a second amorphous cycloolefin polymer composition exhibiting a second glass transition temperature (Tg) which differs from the first glass transition temperature of the first amorphous cycloolefin copolymer composition; and (c) from 25 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 47 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 75° C. to 200° C.

Embodiment No. 48 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 120° C. to 200° C.

Embodiment No. 49 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 75° C. to 120° C.

Embodiment No. 50 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 75° C. to 200° C.

Embodiment No. 51 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 120° C. to 200° C.

Embodiment No. 52 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 75° C. to 120° C.

Embodiment No. 53 is the melt-blend resin composition according to Embodiment No. 46, wherein the first glass transition temperature (Tg) of the first amorphous cycloolefin polymer composition is in the range of from 55° C. to 100° C. and the second glass transition temperature (Tg) of the second amorphous cycloolefin polymer composition is in the range of from 120° C. to 200° C.

Embodiment No. 54 is the melt-blend resin composition according to any one of Embodiment Nos. 46 to 53 wherein the melt-blend resin composition consists essentially of a ternary mixture of the first amorphous cycloolefin polymer composition and the second amorphous cycloolefin polymer composition and the partially crystalline, cycloolefin elastomer of norbornene and ethylene which has at least one glass transition temperature (Tg) in the range of from −10° C. to 15° C., a crystalline melting temperature in the range of from 60° C. to 125° C. and a % crystallinity by weight in the range of from 5% to 40%.

Embodiment No. 55 is the melt-blend resin composition according to any one of Embodiment Nos. 46 to 54, wherein the first amorphous cycloolefin polymer composition is miscible with the second amorphous cycloolefin polymer composition as characterized by a single glass transition temperature (Tg) intermediate of the glass transition of the first amorphous cycloolefin polymer composition and the second amorphous cycloolefin polymer composition.

Embodiment No. 56 is the melt-blend resin composition according to any one of Embodiment Nos. 46 to 54, wherein the first amorphous cycloolefin polymer composition consists essentially of a first copolymer of ethylene and norbornene and second amorphous cycloolefin polymer composition consists essentially of a second copolymer of ethylene and norbornene.

There is further provided medical tubing of the following embodiments:

Embodiment No. 57 is a medical tubing made with a partially crystalline, cycloolefin elastomer of norbornene and ethylene having at least one glass transition temperature (Tg) in the range of from −10° C. to 15° C. and a crystalline melting temperature in the range of from 60° C. to 125° C. and a % crystallinity by weight in the range of from 5% to 40%.

Embodiment No. 58 is a medical tubing according to Embodiment No. 57, wherein the partially crystalline elastomer of norbornene and ethylene has at least one glass transition temperature in the range of from 0° to 10° C.

Embodiment No. 59 is a medical tubing according to Embodiment No. 57, wherein the partially crystalline elastomer of norbornene and ethylene has a melting temperature in the range of from 70° to 100° C.

Embodiment No. 60 is a medical tubing according to Embodiment No. 57, wherein the partially crystalline elastomer of norbornene and ethylene has a melting temperature in the range of from 80° to 90° C.

Embodiment No. 61 is a medical tubing according to Embodiment No. 57, wherein the partially crystalline elastomer of norbornene and ethylene has a % crystallinity by weight in the range of from 10% to 30%.

Embodiment No. 62 is a medical tubing according to Embodiment No. 57, wherein the partially crystalline elastomer of norbornene and ethylene has a norbornene content in the range of from 3 mol % to 20 mol %.

Embodiment No. 63 is a medical tubing according to Embodiment No. 57, wherein the partially crystalline elastomer of norbornene and ethylene has a norbornene content in the range of from 5 mol % to 15 mol %.

Embodiment No. 64 is a medical tubing according to Embodiment No. 57, wherein the partially crystalline elastomer of norbornene and ethylene has a norbornene content in the range of from 7 mol % to 11 mol %.

Embodiment No. 65 is a medical tubing according to Embodiment No. 57, wherein the partially crystalline elastomer of norbornene and ethylene has a weight average molecular weight in the range of from 25,000 to 500,000 Daltons.

Embodiment No. 66 is a medical tubing according to Embodiment No. 57, wherein the partially crystalline elastomer of norbornene and ethylene has a weight average molecular weight in the range of from 50,000 to 450,000 Daltons.

Embodiment No. 67 is a medical tubing according to Embodiment No. 57, wherein the partially crystalline elastomer of norbornene and ethylene has a weight average molecular weight in the range of from 75,000 to 300,000 Daltons.

Embodiment No. 68 is a melt-blend resin composition according to Embodiment No. 57, wherein the partially crystalline elastomer of norbornene and ethylene has a weight average molecular weight in the range of from 100,000 to 200,000 Daltons.

Embodiment No. 69 is a medical tubing according to Embodiment No. 57, wherein the partially crystalline elastomer of norbornene and ethylene exhibits a Melt Volume Rate @ 260° C. and 2.16 kg load of from 2 ml/10 min to 50 ml/10 min.

Embodiment No. 70 is a medical tubing according to Embodiment No. 57, wherein the partially crystalline elastomer of norbornene and ethylene exhibits a Melt Volume Rate @ 260° C. and 2.16 kg load of from 4 ml/10 min to 35 ml/10 min.

Embodiment No. 71 is a medical tubing according to Embodiment No. 57, wherein the partially crystalline elastomer of norbornene and ethylene exhibits a Melt Volume Rate @ 260° C. and 2.16 kg load of from 6 ml/10 min to 24 ml/10 min.

Embodiment No. 72 is a medical tubing according to Embodiment No. 57, wherein the partially crystalline elastomer of norbornene and ethylene exhibits a Melt Volume Rate @ 260° C. and 2.16 kg load of from 8 ml/10 min to 16 ml/10 min.

Embodiment No. 73 is a medical tubing according to Embodiment No. 57, wherein the tubing consists essentially of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 74 is a medical tubing prepared from a blend of: (a) an amorphous cycloolefin polymer composition consisting essentially of one or more copolymers of ethylene and norbornene exhibiting a glass transition temperature in the range of from 30° C. to 200° C.; and (b) a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 75 is a medical tubing according to any one of Embodiments Nos. 57 to 74, having a wall thickness greater than 25 mils.

Embodiment No. 76 is a medical tubing according to any one of Embodiments Nos. 57 to 75, having a wall thickness greater than 30 mils.

Embodiment No. 77 is a medical tubing according to any one of Embodiments Nos. 57 to 76, having a wall thickness of 35 mils or more.

Embodiment No. 78 is a medical tubing according to any one of Embodiments Nos. 57 to 77, having a wall thickness greater than 25 and less than 50 mils.

Embodiment No. 79 is a medical tubing according to any one of Embodiment Nos. 57 to 78, having a wall thickness greater than 30 mils and less than 50 mils.

Embodiment No. 80 is a medical tubing according to any one of Embodiments Nos. 57 to 79, having an inside diameter/wall thickness ratio of less than 3.9.

Embodiment No. 81 is a medical tubing according to any one of Embodiments Nos. 57 to 80, having an inside diameter/wall thickness ratio of less than 3.5.

Embodiment No. 82 is a medical tubing according to any one of Embodiments Nos. 57 to 81, having an inside diameter/wall thickness ratio of less than 3.

Embodiment No. 83 is a medical tubing according to any one of Embodiments Nos. 57 to 82, having an inside diameter/wall thickness ratio of less than 2.75.

Embodiment No. 84 is a medical tubing according to any one of Embodiments Nos. 57 to 83, having an inside diameter/wall thickness ratio of less than 3.9 and greater than 2.25.

Embodiment No. 85 is a medical tubing according to any one of Embodiments Nos. 57 to 84, having an inside diameter/wall thickness ratio of less than 3.5 and greater than 2.25.

Embodiment No. 86 is a medical tubing according to any one of Embodiments Nos. 57 to 85, having an inside diameter/wall thickness ratio of less than 3 and greater than 2.25.

Embodiment No. 87 is a medical tubing according to any one of Embodiments Nos. 57 to 86, having a multi-layer construction.

Embodiment No. 88 is a medical tubing according to any one of Embodiment Nos. 57 to 87, having a multi-layer construction wherein at least one layer comprises amorphous cycloolefin containing polymer with a glass transition temperature above 30 degrees Celsius.

Embodiment No. 89 is a medical tubing according to any one of Embodiment Nos. 57 to 88, having a single-lumen construction.

Embodiment No. 90 is a medical tubing according to any one of Embodiment Nos. 57 to 89, having a multi-lumen construction.

While the invention has been described in detail, modifications within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. Medical tubing made with a partially crystalline, cycloolefin elastomer of norbornene and ethylene having at least one glass transition temperature (Tg) of less than 30° C., a crystalline melting temperature of less than 125° C. and a % crystallinity by weight of 40% or less.

2. Medical tubing according to claim 1, wherein the tubing consists essentially of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

3. Medical tubing according to claim 1, having a wall thickness greater than 25 mils.

4. Medical tubing according to claim 1, having a wall thickness greater than 30 mils.

5. Medical tubing according to claim 1, having a wall thickness of 35 mils or more.

6. Medical tubing according to claim 1, having a wall thickness greater than 25 and less than 50 mils.

7. Medical tubing according to claim 1, having a wall thickness greater than 30 mils and less than 50 mils.

8. Medical tubing according to claim 1, having an inside diameter/wall thickness ratio of less than 3.9.

9. Medical tubing according to claim 1, having an inside diameter/wall thickness ratio of less than 3.5.

10. Medical tubing according to claim 1, having an inside diameter/wall thickness ratio of less than 3.

11. Medical tubing according claim 1, having an inside diameter/wall thickness ratio of less than 2.75.

12. Medical tubing according to claim 1, having an inside diameter/wall thickness ratio of less than 3.9 and greater than 2.25.

13. Medical tubing according to claim 1, having an inside diameter/wall thickness ratio of less than 3.5 and greater than 2.25.

14. Medical tubing according to claim 1, having an inside diameter/wall thickness ratio of less than 3 and greater than 2.25.

15. Medical tubing according to claim 1, having a multi-layer construction, wherein at least one layer comprises a partially crystalline, cycloolefin elastomer of norbornene and ethylene having at least one glass transition temperature (Tg) of less than 30° C., a crystalline melting temperature of less than 125° C. and a % crystallinity by weight of 40% or less.

16. Medical tubing according to claim 15, having a multi-layer construction, wherein at least one layer comprises a partially crystalline, cycloolefin elastomer of norbornene and ethylene having at least one glass transition temperature (Tg) of less than 30° C., a crystalline melting temperature of less than 125° C. and a % crystallinity by weight of 40% or less and at least one layer is formed substantially without a partially crystalline, cycloolefin elastomer of norbornene and ethylene having at least one glass transition temperature (Tg) of less than 30° C., a crystalline melting temperature of less than 125° C. and a % crystallinity by weight of 40% or less.

17. Medical tubing according to claim 1, having a multi-layer construction wherein at least one layer comprises amorphous cycloolefin containing polymer with a glass transition temperature above 30 degrees Celsius.

18. Medical tubing according to claim 17, having a multi-layer construction wherein at least one layer comprises amorphous cycloolefin containing polymer with a glass transition temperature above 30 degrees Celsius melt blended with a partially crystalline, cycloolefin elastomer of norbornene and ethylene having at least one glass transition temperature (Tg) of less than 30° C., a crystalline melting temperature of less than 125° C. and a % crystallinity by weight of 40% or less.

19. Medical tubing according to claim 1, having a single-lumen construction.

20. Medical tubing according to claim 1, having a multi-lumen construction.
